(19) United States
(12) Patent Application Publication
(10) Pub. No.: US 2003/0039453 A1
(43) Pub. Date: Feb. 27, 2003

(54) STRAIN RELIEF BOOT; OPTICAL CONNECTOR AND BOOT ASSEMBLY; AND METHODS

(76) Inventors: Marlon E. Holmquist, Gibbon, MN (US); Paul M. Keltgen, Hutchinson, MN (US)

Correspondence Address: MERCHANT & GOULD PC, P.O. BOX 2903, MINNEAPOLIS, MN, 55402-0903, US

(21) Appl. No.: 09/939,053

(22) Filed: Aug. 24, 2001

(51) Int. Cl. G02B 6/36

(52) U.S. Cl. 385/86

(57) ABSTRACT

A strain relief boot and an optical connector assembly includes an optical connector having a cable with a power transmitting optical fiber and a boot. The boot has a central, hollow tube that holds the cable. The boot includes a series of discrete segments secured together, with each of the segments being preferably slidably connected together with a ball and socket joint. The boot may be manipulated into angles and the cable placed under tension forces, without loss of power transmission to the connector. Methods of assembling and using the boot are provided.

### TECHNICAL FIELD

This disclosure relates to strain relief boots, assemblies using strain relief boots, and methods. In particular, this disclosure relates to strain relief boots utilized with optical fiber connectors, boot and optical fiber connector assemblies, and methods of using boots and optical fiber connectors.

### BACKGROUND

Connectors are used for joining light-transmitting optical fiber cables to transmitter devices, receiver devices, or to other cables. If optical fiber cables are kinked or bent severely, they can be damaged or result in the loss of power transmission. Thus, as the optical fiber cable projects away from the connector, it is desirable that the fiber project in a manner that will not stress or kink the fiber.

Typically, the ideal condition for an optical fiber cable is to project straight away from its connection. It is not always possible, however, to project the cable in a straight line from the connector, especially when routing the cable in tight quarters. Improvements in this area are desirable.

### SUMMARY

In one aspect, this disclosure concerns a strain relief boot usable with a connector. In preferred embodiments, the boot is in the form of a plurality of segments, connected together, and slidable or rotatable relative to each other. In preferred embodiments, some of the segments have the form of at least one of a ball and socket.

In preferred embodiments, the boot is utilized with an optical connector. Preferably, the boot, with the optical connector, is bendable from a straight position to an angle of 135 degrees, and under a tension of at least 0.25 kgf, without incurring an increase in loss of power transmission in the optical connector, on the orders of greater than 0.3 dB-0.5 dB. Further, in preferred embodiments, the boot with the optical connector is bendable from a straight position to an angle of 90 degrees and under a tension of at least 2.0 kgf, without incurring in an increase in loss of power transmission in the connector, on the order of greater than 0.3-0.5 dB. In addition, the boot with the optical connector is bendable from a straight position to an angle of 90° under a tension of 3.4 kgf without incurring an increase in loss of power transmission in the connector of greater than 0.3-0.5 dB after the load is removed.

Methods of utilizing an optical connector are provided, including operably installing the optical connector into a strain relief boot. The boot with the connector therein, is bent to an angle of 90 degrees under a tension force of at least 2.0 kgf and maintaining power transmission in the optical connector. Further, the boot, with the optical connector, is bent to an angle of 135 degrees with a tension force of at least 0.25 kgf, and maintaining power transmission in the optical connector.

### BRIEF DESCRIPTION OF THE DRAWINGS

FIG. 1 is a perspective view of an optical connector and strain relief boot assembly, constructed according to principles of this disclosure;

FIG. 2 is cross-sectional view of the optical connector and strain relief boot assembly depicted in FIG. 1;

FIG. 3 is an exploded perspective view of the strain relief boot assembly depicted in FIGS. 1 and 2;

FIG. 4 is a perspective view of the connector and strain relief boot assembly depicted in FIGS. 1 and 2, and bent at an angle;

FIG. 5 is a cross-sectional view of the strain relief boot depicted in FIGS. 1, 2 and 4, and shown bent an angle;

FIG. 6 is a cross-sectional view of the strain relief boot depicted in FIGS. 1-5;

FIG. 7 is a cross-sectional view of a link utilized in the strain relief boot depicted in FIG. 6, the cross-section being taken along the line 7-7 of FIG. 9;

FIG. 8 is an end view of the link depicted in FIG. 7;

FIG. 9 is an end view of the link depicted in FIG. 7, the end view being of the end opposite to that depicted in FIG. 8;

FIG. 10 is a cross-sectional view of a terminal holder utilized in the boot depicted in FIG. 6, the cross-section being taken along the line 10-10 of FIG. 12;

FIG. 11 is an end view of the terminal holder depicted in FIG. 10;

FIG. 12 is an end view of the terminal holder depicted in FIG. 10, the end view being of the end opposite to that depicted in FIG. 11;

FIG. 13 is a cross-sectional view of a link cover utilized in the boot depicted in FIG. 6, the cross-section being taken along the line 13-13 of FIG. 15;

FIG. 14 is an end view of the link depicted in FIG. 13; and

FIG. 15 is an end view of the link cover depicted in FIG. 13, the end view being of the end opposite to that depicted in FIG. 14.

### DETAILED DESCRIPTION

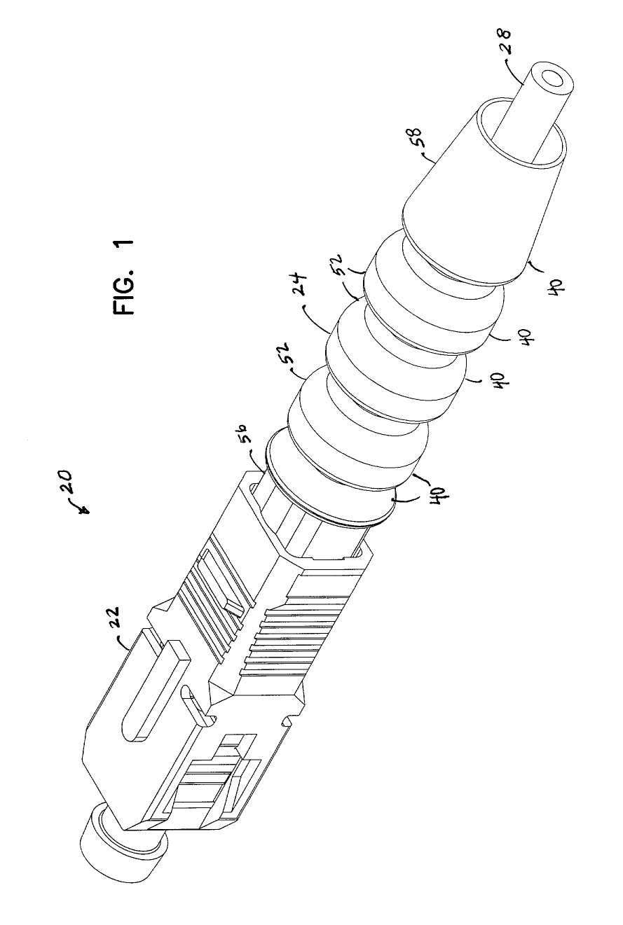

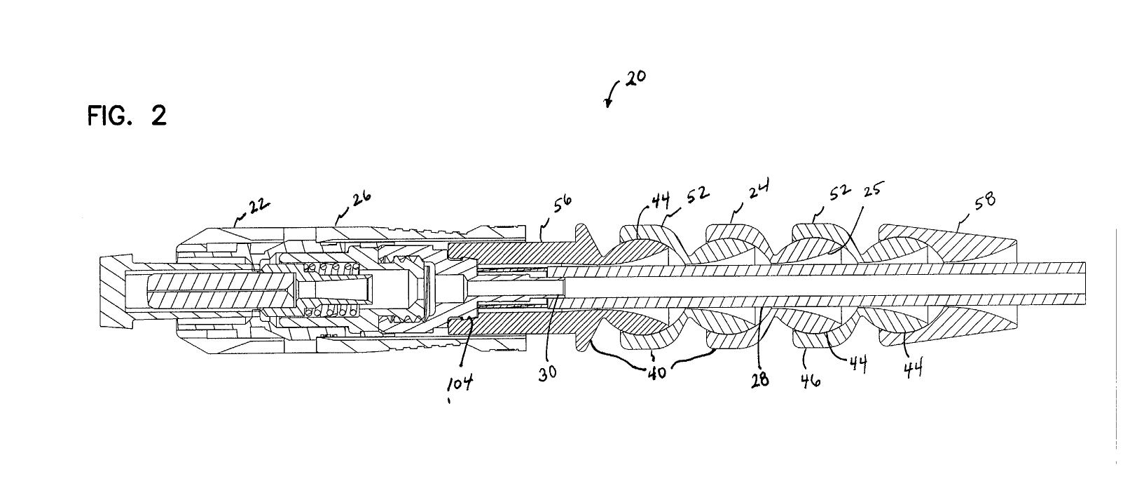

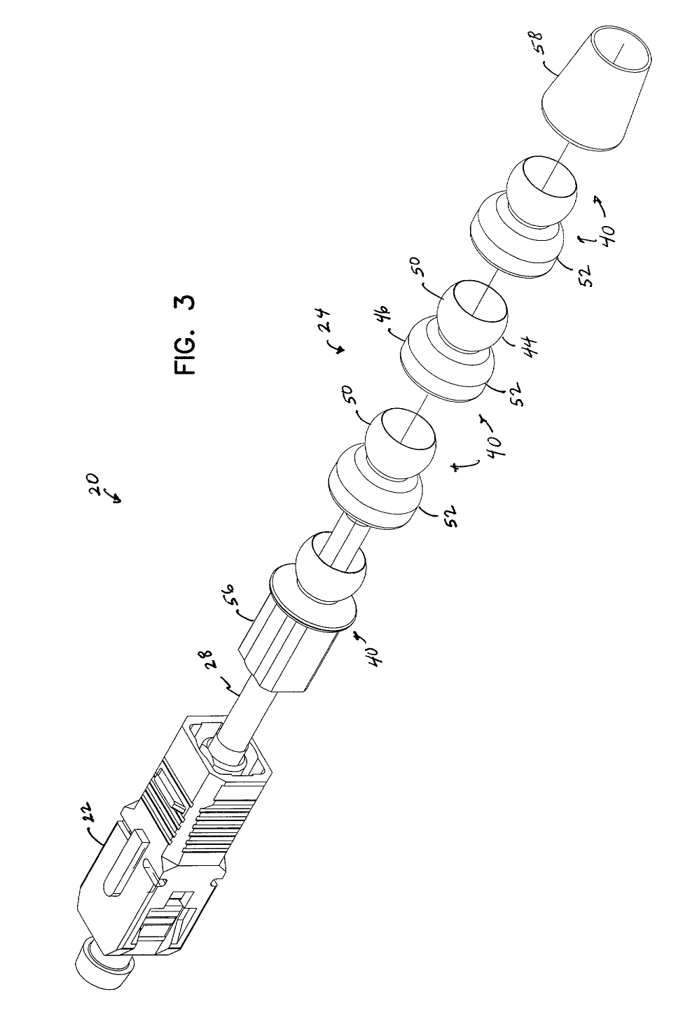

In FIG. 1, a perspective view of an optical connector and boot assembly is shown generally at 20. The assembly 20 includes an optical connector 22 and a strain relief boot 24. In FIG. 2, the connector 22 is depicted in cross-section, and includes a connector housing 26 holding a cable 28, which surrounds an optical fiber 30. As can be seen in FIG. 2, the cable 28 holding the optical fiber 30 extends from the housing 26 and is held by the boot 24. The connector 22 may be any type of optical connector. One usable optical connector is an SC type, available from ADC Telecommunications, Inc. of Minnetonka, Minn.

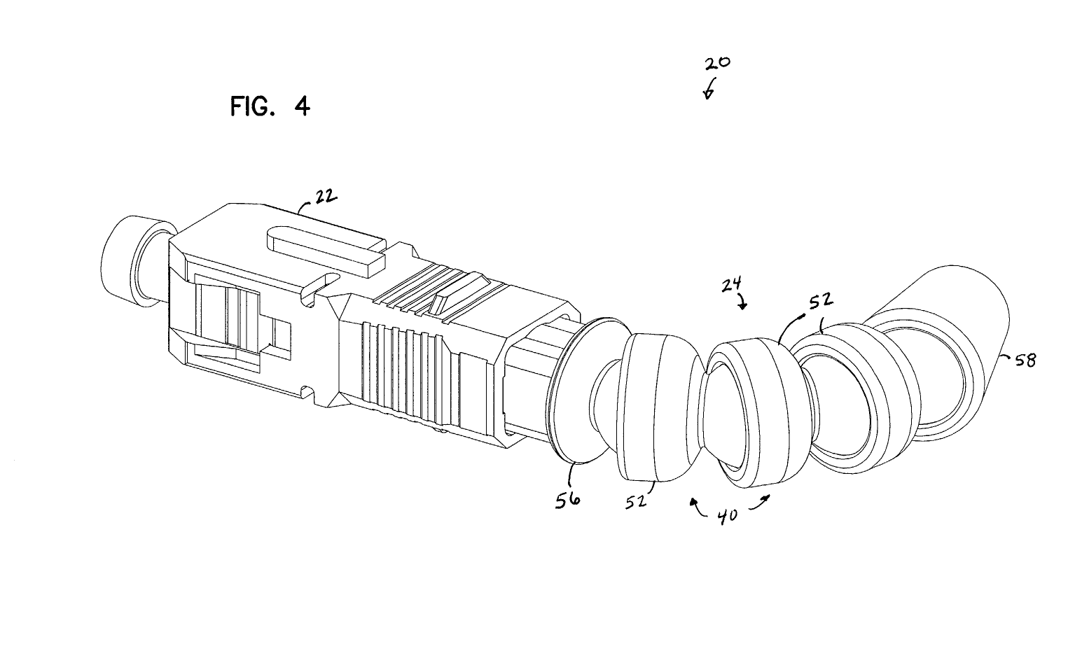

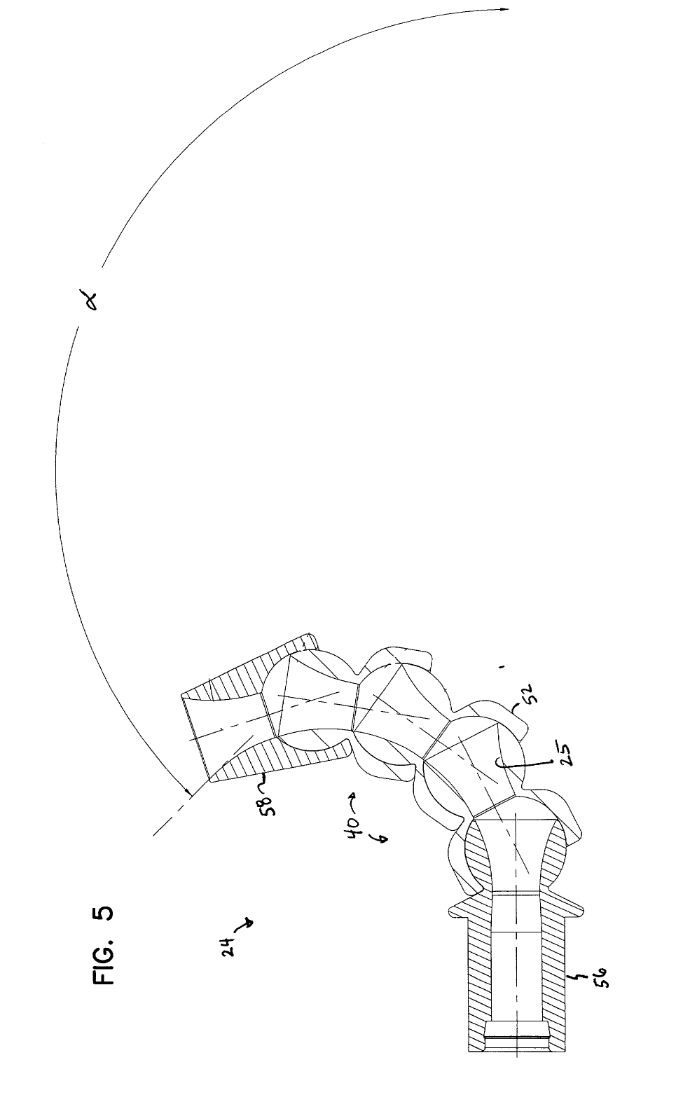

The strain relief boot 24 is constructed and arranged to permit the cable, holding the optical fiber, to be bent through a range of angles without incurring an increase in loss of power transmission to the connector 22. As used herein, when referencing bending the strain relief boot 24 through a range of angles, the angle is measured from an initial position, where the boot 24 is straight (FIG. 2), to the outermost position that the boot 24 is bent. Thus, in FIG. 5, the angle referenced is the angle α measured from the horizontal. By the term “straight”, it is meant the configuration depicted in FIG. 2, where the boot 24 is not bent; alternatively, it can be expressed as having an angle of 180 degrees between opposite ends. One example is depicted in FIG. 4, in which the boot 24 is shown bent at an angle α. In FIG. 5, the boot 24 is shown bent at an angle α of about 135 degrees.

The boot 24 is constructed and arranged to permit bending through angles of at least 135 degrees, and with a certain tension force applied thereto, without an increase in loss of power transmission. In some embodiments, it may be possible to bend the boot 24 more than 135 degrees. In particular, it has been found that certain preferred embodiments of the boot 24 comply with Telcordia Technologies Generic Requirements GR-326-CORE standard (September 1999). Specifically, it has been found that certain preferred embodiments of the boot 24 comply the test for power transmission with applied tensile load, as given in Section 4.4.3.5. The complete standard for GR-326-CORE (September 1999) is incorporated herein by reference. Specifically, preferred embodiments of the boot 24 are able to sustain a tension force of at least 2.0 kgf while bent at 90 degrees (FIG. 4) without incurring an increase in loss of power transmission of greater than 0.3-0.5 dB; and a tension force of 3.4 kgf without incurring an increase in power loss of greater than 0.3-0.5 dB after the load is removed. Further, it can sustain a load of at least 0.25 kgf while bent at an angle of 135 degrees (FIG. 5) without incurring an increase in power loss of greater than 0.3-0.5 dB. The boot 24 satisfies these tests, regardless of the media type utilized. By the term “media type” and variants thereof, it is meant the definition as provided in GR-326-CORE standard; i.e., type 1 media being a reinforced jacketed cable of any diameter used as jumper cordage; type 2 media being cable with 900 micrometer buffer coating that may or may not be reinforced; and type 3 media being a connector mounted on fiber with a 250 micrometer coating.

Preferably, the boot 24 includes a plurality of distinct or discrete segments 40 that are selectively assembled or connected together based on the desired length of the boot 24. In preferred embodiments, the segments 40 are movable or slidable relative to an adjacent segment 40, such that the boot 24 may be manipulated or bent into a desired angle. Preferably, the boot 24 defines a central receiving channel 25 for receiving the cable 28.

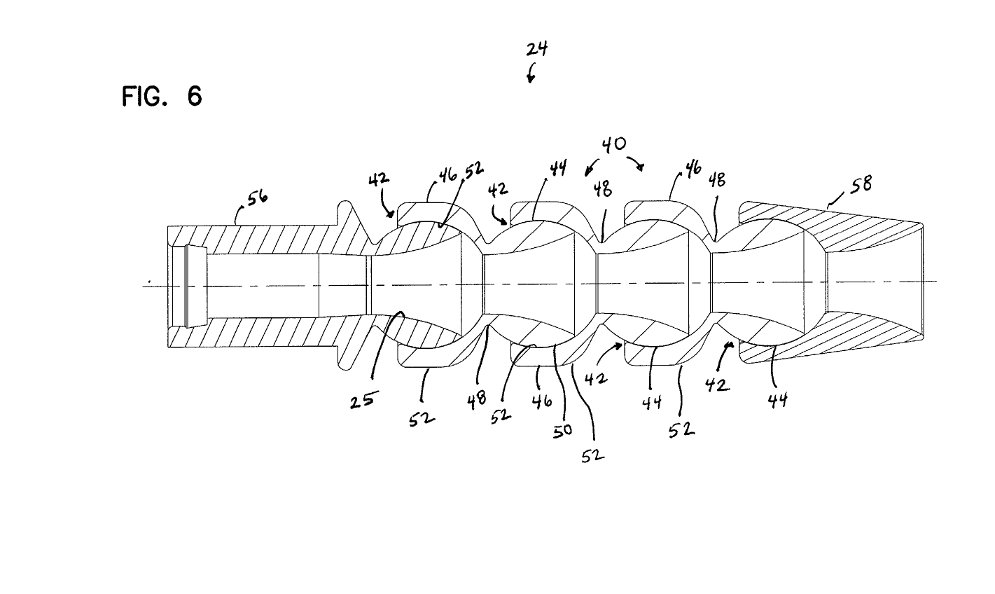

In preferred embodiments, each of the segments 40 is slidably connected to an adjacent segment 40 at a ball and socket joint 42, FIG. 6. By “ball and socket joint”, it is meant a point of articulation in which a piece with a rounded surface moves within a socket, so as to allow motion in every direction, within certain limits.

In general, to result in the ball and socket joints 42, each of the segments 40 includes first and second sections 44, 46 joined by a reduced dimension neck section 48, FIG. 6. The first and second sections 44, 46 are related to each other such that the first section 44 has an outermost dimension that is less than an outermost dimension of the second section 46. Further, the outer surface 50 of the first section 44 has a smooth, curved, rounded shape, while the inner surface 52 of the second section 46 also has a smooth, rounded, curved surface. The inner dimension (for example, diameter) of the inner surface 52 is sized appropriately to receive within and to mateably engage the first section 44 to result in the ball and socket joint 42. In particular, the inner surface 52 and the outer surface 50 will be in slidable engagement with each other, while the first section 44 is held within the second section 46. As can be appreciated by reviewing the cross-section shown in FIG. 6, each one of the first sections 44 is operably received within an adjacent one of the second sections 46 to result in the ball and socket joint 42.

The boot 24 is configurable from a variety of types and numbers of segments 40. In general, the boot 24 will include a plurality of links 52, at least one terminal holder 56, and an optional link cover 58. The number of links 54 used for the boot 24 will depend upon the particular application, as the length of the boot 24 will vary depending upon how many links 54 are utilized.

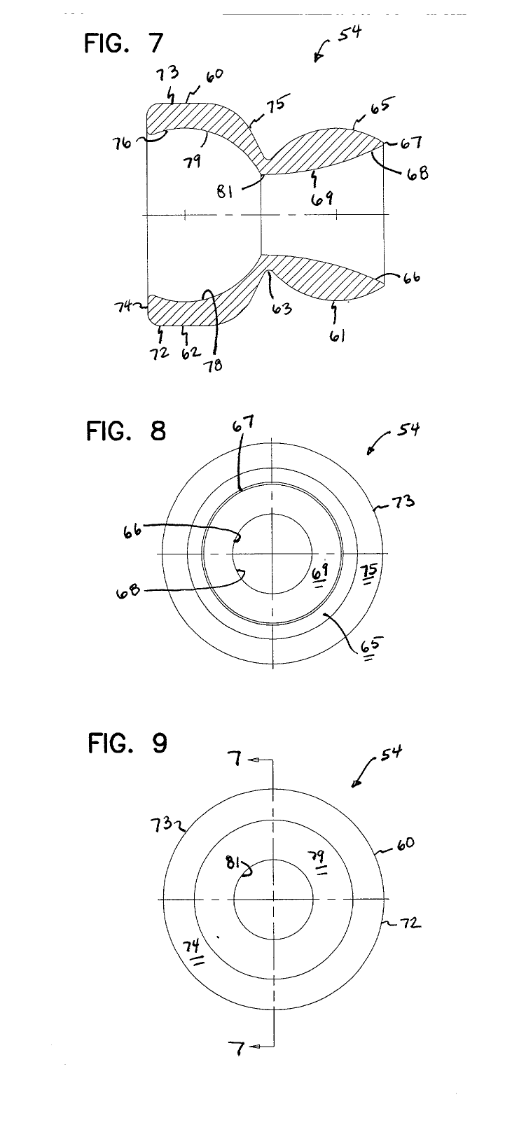

Attention is now directed to FIGS. 7-9, where one particular embodiment of link 54 is illustrated. In the particular embodiment shown, the link 54 has a surrounding wall 60 including first and second link sections 61, 62 and a link neck 63 being between and joining the first link section 61 and the second link section 62. The first link section 61 is configured to form the “ball” of the ball and socket joint 42. As such, the first link section 61 is a rounded protrusion, having a smooth, curved outer surface 65 extending from an end face 67 to the link neck 63. The end face 67 defines an aperture 66 that provides access into an open, hollow receiving chamber 68 defined by an inner wall surface 69. In the particular embodiment illustrated, the first link section 61 has a circular cross-section. As such, the outer surface 65 defines an outermost dimension, which corresponds to a diameter. The receiving chamber 68 is formed as a negative cylinder, thus, having a circular cross-section. The receiving chamber 68 defines an inner diameter.

The second link section 62 is immediately adjacent to the first link section 61, with the link neck 63 being therebetween. The second link section 62 has an outer surface 72 defined by the wall 60. The outer surface 72, in the one depicted, includes a cylindrical outer surface 73 extending from an end face 74 to a ramp surface 75. The ramp surface 75 extends from the cylindrical surface 73 to the neck 63. As such, the ramp surface 75 is angled acutely relative to the cylindrical outer surface 73. The cylindrical outer surface 73 defines an outermost dimension which, in this embodiment, corresponds to an outer diameter.

The end face 74 defines an aperture 76, which provides access into a receiving chamber 78 that is defined by an inner wall surface 79. The receiving chamber 78 is sized appropriately to function as the “socket” in the ball and socket joint 42.

From a review of FIG. 7, it can be appreciated that the receiving chamber 78 of the second link section 62 is in communication with the receiving chamber 68 of the first link section 61. Indeed, in the preferred embodiment illustrated, the receiving chambers 68, 78 are aligned co-axially. The receiving chambers 68, 78, as well as a receiving chamber 81 defined by the link neck 63 are, in the preferred embodiment, sized to receive the connector cable 28 (FIG. 2) therein.

In operation, each of the links 54 are connected together as shown in FIGS. 2 and 6. The aperture 76 is sized to have a diameter that is smaller than the outer diameter of the first link section 61, in order to hold the first link section 61 within the receiving chamber 78. The receiving chamber 78 is sized to have its area of largest diameter to be larger than the outer diameter of the first link section 61, to permit the first link section 61 to slidably move within the receiving chamber 78. The amount of clearance between these dimensions may be adjusted in order to have a tighter or looser fit. For example, in some applications, it may be desirable to have the boot 24 function as an angled connector, such as a 90 degree connector. The links 54 may be snapped together, in preferred embodiments.

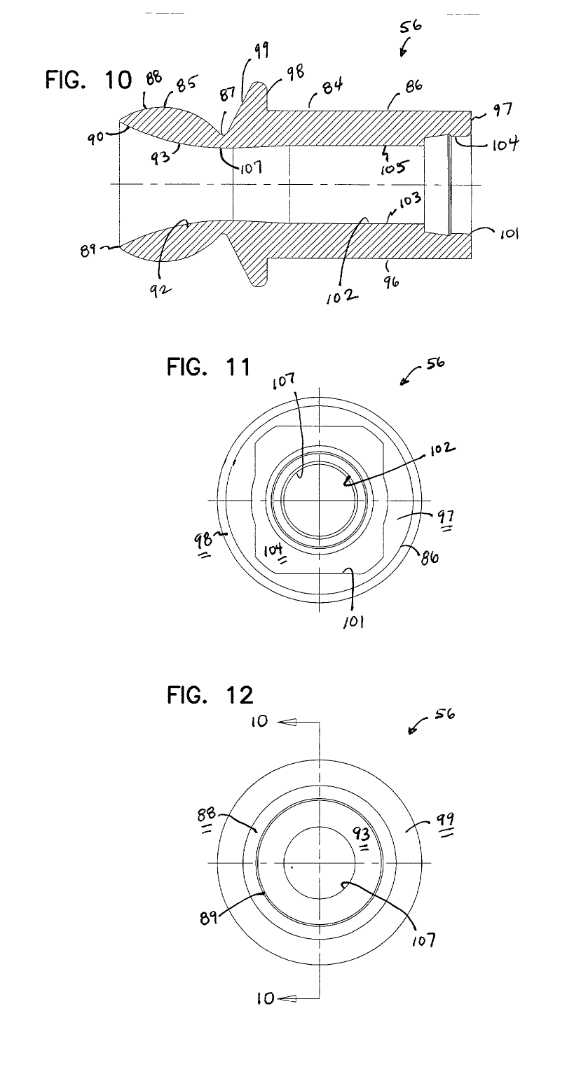

Attention is now directed to FIGS. 10-12. One embodiment of terminal holder 56 is illustrated in detail in FIGS. 10-12. The terminal holder 56, in preferred arrangements, will be the segment 40 that is adjacent to and against the housing 26 of the optical connector 22. Preferably, the terminal holder 56 has an overall length that is greater than the length of one of the links 54. This is to provide at least some minimum of support to the cable 28 that extends immediately from the housing 26 and prevent unintended kinks or curves in the cable 28 in this region immediately in the vicinity of the housing 26. In many preferred arrangements, the terminal holder 56 will be at least 50 percent longer than one of the links 54, and in some cases, will be 75%-100% longer than one of the links 54.

While the boot 24 will typically have at least two links 54, and in many cases, four or more links 54, the boot 24 typically has a single terminal holder 56.

The terminal holder 56, in the embodiment illustrated, includes a surrounding wall 84, a first terminal holder section 85, a second terminal holder section 86, and a terminal holder neck 87 extending between and joining the first terminal holder section 85 and the second terminal holder section 86. As can be seen in FIG. 10, the terminal holder neck 87 defines an outermost dimension, in the embodiment shown a diameter, that is less than the outermost dimension of the first terminal holder section 85 and of the second terminal holder section 86. As can also be seen in FIG. 10, the first terminal holder section 85 has an outermost dimension, in this case diameter, that is less than the outermost dimension of the second terminal holder section 86.

The first terminal holder section 85 has an outer surface 88 that is shaped to be received within one of the receiving chambers 78 of one of the links 54. As such, the outer surface 88 is smooth and curved extending from an end face 89 to the terminal holder neck 87. In preferred embodiments, the first terminal holder section 85 has an identical shape as the first link section 61. This helps to ease interchangeability.

The end face 89 defines an aperture 90 in communication with and access to a receiving chamber 92. The receiving chamber 92 is defined by an inner wall surface 93. In preferred embodiments, the inner wall surface 93 is cylindrical in shape. The receiving chamber 92 is sized to accommodate the cable 28.

The second terminal holder section 86 extends from an end face 97 to a flange 98. The outer surface 96, in the preferred embodiment shown, is cylindrical in shape. The flange 98 is angled normally relative to the outer surface 96 and ends at ramp surface 99. The flange 98, in the embodiment shown, is generally parallel to the end face 89 and the end face 97. The ramp surface 99 terminates at the terminal holder neck 87. In use, the flange 98 can operate as a handle for manipulating the assembly 20. The end face 97 is at an end opposite from the end face 89. The end face 97 defines an aperture 101 that is in communication with a receiving chamber 102 defined by an inner surface 103. The receiving chamber 102 includes a countersink region 104 that is immediately adjacent to the end face 97. The countersink region 104 defines an inner diameter that is greater than the inner diameter of region 105. Region 105 is immediately adjacent to the receiving chamber 92 and the receiving chamber 107 defined by the terminal neck 87. As can be seen in FIG. 2, countersink region 104 helps to provide an interlock with the connector 22, by receiving within a portion of the connector 22.

The receiving chambers 92, 107 and 102 are shown, in this particular embodiment, as being co-axially aligned. Further, the receiving chamber 102 has a diameter that is within 5 percent of the diameter of the receiving chamber 92, in this particular embodiment. This arrangements permits the cable 28 to extend from the connector housing 26 smoothly into the boot 24. The countersink region 104 also helps to provide a smooth transition between the housing 26 and the cable 28.

When the boot 24 is secured to the connector 22, in preferred embodiments, the terminal holder 56 is positioned immediately adjacent to and against the connector housing 26, such that the end face 97 abuts against the housing 26. The cable 28 extends out of the connector housing 26 and into the receiving chambers 102, 107 and 92. Preferably, a plurality of links 54 then extends from the terminal holder 56. The first link 54 is slidably connected to the terminal holder 56 by having the second link section 62 be snapped over in a manner to hold the first terminal holder section 85. In this manner, the first terminal holder section 85 will be slidably contained within the receiving chamber 78 of the link 54. The next link 54 is then connected to the first link 54 by snapping the second link section 62 over the first link section 61. This is continued until the boot 24 has the desired length. As can be seen in FIG. 2, the cable 28 extends through the receiving chambers defined by each of the segments 40 (including the terminal holder 56 and each of the links 54).

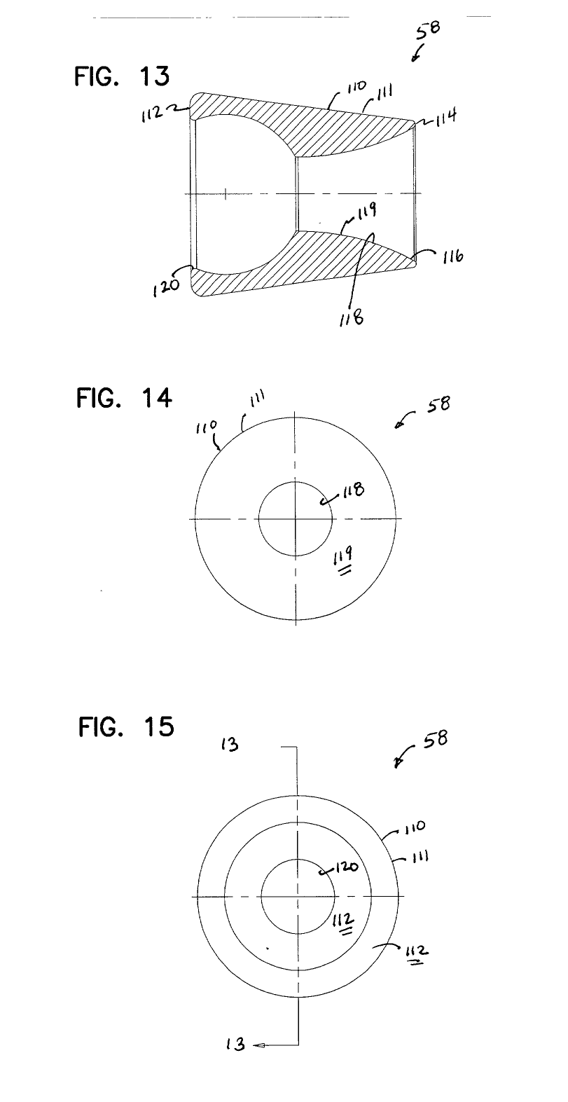

As mentioned above, the boot 24 may include an optional link cover 58. The link cover 58 provides some protection to the cable 28, but has a primary purpose of being aesthetically pleasing. FIGS. 13-15 show one particular, preferred embodiment of the link cover 58. In the embodiment shown, the link cover 58 includes a surrounding wall 110 having an outer surface 111 extending between an end face 112 and an end face 114. The end face 114 terminates at an aperture 116. The aperture 116 is in communication with and allows access to an inner receiving chamber 118 defined by an inner surface 119 of the surrounding wall 110. The end face 112 defines an aperture 120 that is in communication with and allows access to the receiving chamber 118.

When used for the boot 24, the link cover 58 extends over and holds the link 54 that is most remote from the terminal holder 56. In particular, the first link section 61 fits within and is received by the receiving chamber 118 by way of a slidable connection to form ball and socket joint 42. The aperture 116 permits the cable 28 to exit the boot 24.

From a review of the cross-sections shown in FIGS. 2, 5-7, 10, and 13, it will be appreciated that the portions along the boot central channel 25 are smooth and contain no sharp corners or bends. In this way, the segments 40 are configured especially for receiving and holding the optical fiber 30.

In operation, the boot 24 may be used with the optical connector 22 as follows. A kit containing the discrete, unassembled segments 40 is provided. The boot 24 is assembled by connecting one of the links 54 (a “first link 54”) to the terminal holder 56. This is done by snapping the terminal holder first section 85 into the second link section 62 to form ball and socketjoint 42 therebetween. Next, another link 54 (a “second link 54”) is taken and attached to the first link 54. This second link 54 is attached to the first link 54 by placing the second link section 62 of the second link 54 over and around to hold the first link section 61 of the first link 54. The desired number of links 54 may then be added in an identical process. If desired, the optional link cover 58 may be snapped over the final link 54 by placing the first link section 61 within the receiving chamber 118 of the link cover 58.

The optical connector 22 may then be operably installed within the boot 24. This is done by threading the cable 28 through the central receiving channel 25 defined by each of the segments 40. The boot 24 is grasped and pushed against the connector housing 26, such that the end face 97 of the terminal holder 56 engages and abuts the connector housing 26.

As discussed above, the boot 24 will permit the optical connector 22 to remain operable without incurring an increase in loss of power transmission of greater than 0.3-0.5 dB, even when bent at an angle of 90 degrees and under a tension force of at least 2 kgf to the boot. Further, as explained above, the boot 24 with the cable 28 therein may be bent at an angle of 135 degrees (FIG. 5) under a tension force of at least 0.25 kgf without an increase in loss of power transmission in the connector 22, greater than 0.3-0.5 dB.

As explained above, if desired, each of the segments 40 may be configured to have close clearance at the ball and socketjoints 42, such that the boot 24 may be manipulated to desired angles and held at those desired angles through the tight fit between the segments 40. If designed in this way, the user may decide what angle the user wishes to fix, bend the boot 24 to hold that angle, and then thread the cable 28 therethrough.

What is claimed is:

1. A strain relief boot for a connector; the boot comprising:
(a) at least one link; said link including a surrounding wall including first and second link sections and a link neck;
i) said first link section and said second link section each having an outermost cross-sectional dimension;
(A) the outermost cross-sectional dimension of said first link section being less than the outermost cross-sectional dimension of said second link section;
(ii) said link neck being between and joining said first link section and said second link section;
(A) said link neck having an outermost cross-sectional dimension less than the outermost cross-sectional dimensions of each of said first link section and said second link section;
(iii) each of said first link section, said second link section, and said link neck defining a respective receiving chamber;
(b) a terminal holder; said terminal holder including a surrounding wall including a first terminal holder section, a second terminal holder section, and a terminal holder neck;
(i) said first terminal holder section and said second terminal holder section each having an outermost cross-sectional dimension;
(ii) said terminal holder neck being between and joining said first terminal holder section and said second terminal holder section;
(A) said terminal holder neck having an outermost cross-sectional dimension less than the outermost cross-sectional dimensions of each of said first terminal holder section and said second terminal holder section;
(iii) each of said first terminal holder section, said second terminal holder section, and said terminal holder neck defining a respective receiving chamber; and
(iv) said first terminal holder section being inserted within the second link section receiving chamber and being slidably held by said second link section surrounding wall.

2. A strain relief boot according to claim 1 wherein:
(a) the outermost cross-sectional dimension of said first terminal holder section is less than the outermost cross-sectional dimension of said second terminal holder section.

3. A strain relief boot according to claim 2 further including:
(a) a plurality of said links; each of said links including a surrounding wall including respective first and second link sections and a link neck;
(i) each of respective said first link sections and said second link sections each having an outermost cross-sectional dimension;
(A) the outermost cross-sectional dimension of each of respective said first link sections being less than the outermost cross-sectional dimension of each of respective said second link sections;
(ii) each of respective said link necks being between and joining a respective said first link section and said second link section;
(A) each of said link necks having an outermost cross-sectional dimension less than the outermost cross-sectional dimensions of each of respective said first link sections and said second link sections;
(iii) each of respective said first link sections, said second link sections, and said link necks defining a respective receiving chamber;
(b) each of respective second link sections, receiving within a respective second link section receiving chamber, one of a respective first link sections; the surrounding wall of each of the respective second link sections slidably holding the respective first link section.

4. A strain relief boot according to claim 3 wherein:
(a) each of respective outermost cross-sectional dimensions of each of said first link sections, second link sections, and said link necks is a diameter.

5. A strain relief boot according to claim 4 wherein:
(a) each of the outermost cross-sectional dimensions of said first terminal holder section, second terminal holder section, and said terminal holder neck is a diameter.

6. A strain relief boot according to claim 3 wherein:
(a) said boot includes a first end and an opposite second end;
(i) said terminal holder defining said first end; and
(ii) one of said first link sections of said plurality of links defining said second end.

7. A strain relief boot according to claim 6 further comprising:
(a) a link cover having a surrounding wall defining a receiving chamber;
(i) said one of said first link sections defining said second end being inserted within said link cover receiving chamber; said link cover surrounding wall slidably holding said one of said first link sections defining said second end.

8. A strain relief boot according to claim 6 wherein:
(a) said boot is bendable through a range of angles from an initial position, where said boot is straight, to a second position;
(i) said range of angles including up to at least 90 degrees.

9. A strain relief boot according to claim 8 wherein:
(a) said range of angles includes up to at least 135 degrees.

10. A method of using an optical connector; the method including:
(a) providing an operable optical connector including a power transmitting optical fiber and a surrounding cable; the optical fiber and the cable being held within a connector housing;
(b) operably installing the optical connector into a strain relief boot; the strain relief boot having a first end and an opposite second end; the strain relief boot being at an initial position that is straight;
(c) bending the strain relief boot from the initial position, including the optical connector, to an angle of 90 degrees and applying a tension force of at least 2.0 kgf to the boot while at the 90 degree angle without losing power transmission in the optical connector; and
(d) bending the strain relief boot, including the optical connector, to an angle of 135 degrees and applying a tension force of at least 0.25 kgf to the boot while at the 135 degree angle without losing power transmission in the optical connector.

11. A method of using an optical connector according to claim 10 wherein:
(a) said step of operably installing includes installing the connector into a strain relief boot comprising a plurality of distinct segments; each distinct segment being slidably connected to an adjacent distinct segment.

12. A method of using an optical connector according to claim 10 wherein:
(a) said step of operably installing includes installing the connector into a strain relief boot comprising a plurality of distinct segments; the distinct segments including:
(i) a plurality of links; each of the links having a first link section, a second link section, and a link neck;
(A) an outermost dimension of each of the second link sections being greater than an outermost dimension of each of the first link sections; and an outermost dimension of each of the link necks being less than the outermost dimensions of each of the first link sections and second link sections;
(ii) a terminal holder; the terminal holder including a first terminal holder section, a second terminal holder section, and a terminal holder neck;
(A) an outermost dimension of the second terminal holder section being greater than an outermost dimension of the first terminal holder section; an outermost dimension of the terminal holder neck being less than the outermost dimensions of the first terminal holder section and second terminal holder section;
(B) one of the second link sections slidably holding the first terminal holder section; remaining ones of the second link sections slidably holding an adjacent one of the first link sections;
(C) each of the plurality of links and the terminal holder defining a central, receiving chamber holding the optical connector cable;
(D) the terminal holder being adjacent to and against the optical connector cable housing.

13. A method according to claim 10 further including:
(a) using the strain relief boot to direct a path of the surrounding cable by bending the boot to a desired angle;
(i) the strain relief boot holding the surrounding cable at the desired angle.

14. A method according to claim 13 wherein:
(a) said step of using the strain relief boot to direct a path of the surrounding cable by bending the boot to a desired angle includes bending the boot to an angle between 80 and 100 degrees.

15. An optical connector and boot assembly; the assembly comprising:
(a) an operable optical connector including a power transmitting optical fiber and a surrounding cable; a portion of the optical fiber and the surrounding cable being held within a connector housing; and
(b) a boot holding a portion of the cable; the boot having first and second opposite ends; the first end being adjacent to and against the connector housing;
(i) said boot with said optical fiber and surrounding cable being bendable from a straight position to an angle of 135 degrees, under a tension of at least 0.25 kgf, without loss of power transmission in said optical connector; and
(ii) said boot with said optical fiber and surrounding cable being bendable from a straight position to an angle of 90 degrees, under a tension of at least 2.0 kgf, without loss of power transmission in said optical connector.

16. An assembly according to claim 15 wherein:
(a) said boot includes a plurality of discrete segments slidably connected together.

17. An assembly according to claim 16 wherein:
(a) said plurality of discrete segments includes at least at least one link; said link including a surrounding wall including first and second link sections and a link neck;
(i) said first link section and said second link section each having an outermost cross-sectional dimension;
(A) the outermost cross-sectional dimension of said first link section being less than the outermost cross-sectional dimension of said second link section;
(ii) said link neck being between and joining said first link section and said second link section;
(A) said link neck having an outermost cross-sectional dimension less than the outermost cross-sectional dimensions of each of said first link section and said second link section;
(iii) each of said first link section, said second link section, and said link neck defining a respective receiving chamber;
(A) said optical fiber and surrounding cable being held by the receiving chambers of said first link section, said second link section, and said link neck.

18. An assembly according to claim 17 wherein:
(a) said plurality of discrete segments includes a terminal holder; said terminal holder including a surrounding wall including a first terminal holder section, a second terminal holder section, and a terminal holder neck;
(i) said first terminal holder section and said second terminal holder section each having an outermost cross-sectional dimension;
(ii) said terminal holder neck being between and joining said first terminal holder section and said second terminal holder section;
(A) said terminal holder neck having an outermost cross-sectional dimension less than the outermost cross-sectional dimensions of each of said first terminal holder section and said second terminal holder section;
(iii) each of said first terminal holder section, said second terminal holder section, and said terminal holder neck defining a respective receiving chamber;
(A) said ferrule and surrounding cable being held by the receiving chambers of said first terminal holder section, said second terminal holder section, and said terminal holder neck;
(B) said terminal holder second section being adjacent to and against the optical connector housing; and
(iv) said first terminal holder section being inserted within the second link section receiving chamber and being slidably held by said second link section surrounding wall.

19. An assembly according to claim 18 wherein:
(a) said plurality of discrete segments includes a plurality of links; each of said links including a surrounding wall including respective first and second link sections and a link neck;
(i) each of respective said first link sections and said second link sections each having an outermost cross-sectional dimension;
(A) the outermost cross-sectional dimension of each of respective said first link sections being less than the outermost cross-sectional dimension of each of respective said second link sections;
(ii) each of respective said link necks being between and joining a respective said first link section and said second link section;
(A) each of said link necks having an outermost cross-sectional dimension less than the outermost cross-sectional dimensions of each of respective said first link sections and said second link sections;
(iii) each of respective said first link sections, said second link sections, and said link necks defining a respective receiving chamber;
(b) each of respective second link sections, receiving within a respective second link section receiving chamber, one of a respective first link sections; the surrounding wall of each of the respective second link sections slidably holding the respective first link section.

20. An assembly according to claim 19 wherein:
(a) each of respective outermost cross-sectional dimensions of each of said first link sections, second link sections, and said link necks is a diameter; and
(b) each of the outermost cross-sectional dimensions of said first terminal holder section, second terminal holder section, and said terminal holder neck is a diameter.

21. An assembly according to claim 19 wherein:
(a) said terminal holder defines said first end of said boot; and
(b) one of said first link sections of said plurality of links defines said second end.

22. An assembly according to claim 21 wherein:
(a) said plurality of discrete segments further includes a link cover defining a receiving chamber;
(i) said one of said first link sections defining said second end being inserted within and slidably held by said link cover receiving chamber.

23. A strain relief boot and an optical connector assembly comprising:
(a) an optical connector including a cable with a power transmitting central ferrule; and
(b) a boot defining a central, hollow tube holding said cable;
(i) said boot including a plurality of discrete segments secured together;
(ii) each of the segments being slidably connected to an adjacent segment at a ball and socket joint.

24. An assembly according to claim 23 wherein:
(a) each of said segments includes a first section defining a first outer diameter; a neck section defining a neck outer diameter; and a second section defining a second outer diameter;
(i) said first outer diameter being less than said second outer diameter and greater than said neck outer diameter;
(ii) said neck section being between said first section and said second section; and
(b) each of said ball and socket joints including:
(i) one of the first sections being operably received within an adjacent one of the second sections.

25. An assembly according to claim 24 wherein:
(a) one of said segments includes a terminal holder oriented against a housing of said optical connector.

26. An assembly according to claim 25 wherein:
(a) at least one of said segments includes a first link connected to said terminal holder by said ball and socket joint; and
(b) at least one of said segments includes a second link connected to said first link by said ball and socket joint.

27. An assembly according to claim 25 wherein:
(a) at least some of said segments includes a plurality of links; and
(b) one of said segments includes a link cover in receipt of one of said plurality of links.

28. A kit for fitting a strain relief boot to an optical connector; the kit comprising:
(a) an optical connector including a cable with a power transmitting central optical fiber; and
(b) a boot assembly including:
(i) a plurality of discrete segments; each of said discrete segments defining a central tube sized to receive said cable;
(ii) at least some of said discrete segments having both a rounded protrusion section and a receiving chamber;
(iii) each of said discrete segments having at least one of a rounded protrusion section and a receiving chamber; and
(iv) each of said discrete segments being shaped to be snappable together to form ball and socket joints therebetween.

29. A kit according to claim 28 wherein:
(a) one of said segments includes a terminal holder connectable against a housing of said optical connector;
(b) at least one of said segments includes a first link connectable to said terminal holder; and
(c) at least one of said segments includes a second link connectable to said first link.

30. A method of assembling a strain relief boot on an optical connector; the method comprising:
(a) providing an optical connector including a cable with a power transmitting central optical fiber;
(b) providing a terminal holder and a first link; each of the terminal holder and the first link defining a central tube;
(c) snapping the first link onto the terminal holder and forming a ball and socket joint therebetween; the central tube of the terminal holder being in communication with the central tube of the first link to form a boot central channel; and
(d) inserting the optical connector into the boot central channel.

31. A method according to claim 30 further including:
(a) before said step of inserting, snapping a second link onto the first link and forming a ball and socket joint therebetween.

32. A method according to claim 31 further including:
(a) before said step of inserting, snapping a selected number of additional links end-to-end onto the second link and forming a ball and socket joint between each of the links.

33. A method according to claim 32 further including:
(a) before said step of inserting, snapping a link cover onto one of the links.
